(19) United States
(12) Patent Application Publication
(10) Pub. No.: US 2022/0064746 A1
(43) Pub. Date: Mar. 3, 2022

(54) POST-WELD HEAT TREATMENT METHOD FOR 1,300 MPa-LEVEL LOW-ALLOY HEAT TREATED STEEL RAIL

(71) Applicant: PanGang Group Panzhihua Iron & Steel Research Institute Co., Ltd., Panzhihua (CN)

(72) Inventors: Wei BAI, Panzhihua (CN); Dadong LI, Panzhihua (CN); Ruoyu WANG, Panzhihua (CN); Jian DENG, Panzhihua (CN)

(73) Assignee: PanGang Group Panzhihua Iron & Steel Research Institute Co., Ltd., Panzhihua (CN)

(21) Appl. No.: 17/407,512

(22) Filed: Aug. 20, 2021

(30) Foreign Application Priority Data
Aug. 28, 2020 (CN) 202010886023.2

(51) Int. Cl. C21D 9/04; B23K 35/30

(52) U.S. Cl. CPC C21D 9/04; B23K 2101/26; B23K 35/3053

(57) ABSTRACT

The present disclosure relates to the manufacturing of railway steel rail, and a post-weld heat treatment method for 1,300 MPa-level low-alloy heat-treated steel rail. The method comprises: (1) subjecting a steel rail welded joint having a residual temperature of 900-1,100° C. to a first stage cooling to lower the welded joint surface temperature to 650-720° C.; (2) subjecting the steel rail welded joint to a second stage cooling to lower the welded joint surface temperature to 480-550° C.; (3) subjecting the steel rail welded joint to a third stage cooling to lower the welded joint surface temperature to 10-30° C. The heat treatment takes advantage of the welding waste heat and does not require a reheating. The martensitic structure in the metallographic structure of the steel rail welded joint can be controlled to ≤1% and the fatigue life can reach 3 million times, which is conducive to operation safety of the railway.

### FIELD OF INVENTION

The present disclosure relates to the technical field of manufacturing railway steel rail, in particular to a post-weld heat treatment method for 1,300 MPa-level low-alloy heat treated steel rail.

### BACKGROUND

The People's Republic of China (PRC) is a country mainly depending on the railway transportation. The rapid development of the national economy requires the railway system to enhance the transportation density by further improving the running speed, increasing the axle load of the locomotive and cutting down the running interval, thereby impose higher requirements on the steel rail; However, the common carbon steel rail cannot meet the requirements of high-speed railway and heavy-load transportation.

The steel rail can be reinforced by means of heat treatment and alloying process. Heat treatment is the most economical and effective approach for improving the steel rail performance. The alloying process has the advantages of simple production process, and the alloyed rail is generally delivered in a hot rolling state such that the heat energy is saved. The existing researches show that the steel rail with a higher strength can be produced by only utilizing the alloy reinforcement process, but the ductility and toughness of the steel rail are lower. The method of combining low alloy and heat treatment can be used for producing high performance steel rail with high strength, desirable ductility and toughness. Based on the on-line heat treatment technology, and in combination with proportioning of low-content alloy elements, the low-alloy heat treated steel rail with a tensile strength of 1,300 MPa can be produced, the steel rail has desirable ductility and toughness, and the advantages such as wear resistance and contact fatigue resistance, thus it is suitable for heavy haul railway with large axle load.

The addition of alloy elements in the steel rail enhances stability of the super-cooled austenite, so that the Continuous Cooling Transformation (CCT) curve is shifted to the right, and the hardenability is obviously improved. Therefore, when the rail production process of the steel rail is not tightly controlled or the cooling rate is not properly controlled, the martensite is formed in the region of the composition segregation because the normal cooling rate or the cooling rate of an air cooling exceeds the critical cooling rate, it is a problem which cannot be ignored in the production of alloy rails. It is difficult for the steel rail to avoid local segregation resulting from the factors such as the steel-making process, the homogeneity degree of steel, and the cleanliness degree does not reach the standards, given that an existence of segregation and the different chemical compositions of individual micro-region, the Ms temperature (the starting temperature of forming the martensitic structure) points are different, thus the martensite transformation is not synchronous, and martensite is generated in partial regions. At the same time, the segregation can lead to the formation of martensite in the partial steel rail due to segregation under the action of the welding thermal cycle. Even if the final cooling temperature during rapid cooling of the post-weld heat treatment of the rail is higher than the Ms temperature of the steel rail, an existence of local segregation causes that the CCT curve is shifted to the right, and the martensite is formed. In regard to the steel rail with component segregation, the reasonable control of the cooling rate and the final cooling temperature in the cooling process of the post-weld heat treatment of the steel rail is beneficial to reducing and even avoiding the influence of the segregation martensite on the service performance of the steel rail joint.

At present, mobile flash butt welding has become the mainstream steel rail online welding technology in railway construction sites at home and abroad, and for two kinds of steel rails with different strength grades and materials, the difference between the properties of base materials brings huge challenges to the welding process. Moreover, after the steel rail is subjected to the action of welding thermal cycle, a quench-hardened layer of a welding area disappears, and low hardness areas with larger widths are formed on both sides of a weld seam, so that the hardness of the weld seam and the heat affected zone is lower than that of base metal of a steel rail. During the service process of a steel rail mounted on the rail line, a “saddle-shaped” abrasion is easily and initially formed on the railhead tread of a welded joint, such an abrasion not only increase the impact of a wheel rail, but also seriously affect the service life of the steel rail, or even endanger the traffic safety. Therefore, the premise for applying the steel rail is how to recover the mechanical property of the steel rail which is reduced by a welding process.

CN106544933A disclosed a method for post-weld heat processing of a hypereutectoid steel rail and PG4 heat-processing eutectoid pearlite steel rail welded joint, the method comprises the steps that first cooling is conducted to the to-be-cooled rail welded joint obtained through welding until the temperature is lower than 400° C.; then, the rail welded joint obtained after the first cooling is heated to a temperature between 860° C. and 930° C.; and second cooling is then conducted to the rail welded joint until a tread face temperature of the joint is between 410° C. and 450° C. The heterogeneous steel rail welded joint produced with the method can satisfy requirements for passing tests such as a fatigue test, a stretching and impact test and a slow bending test as stipulated in the current railway industry standard TB/T1632.2-2014 “part 2 of steel rail welding: flash butt welding” of China. However, the aforementioned invention relates to the post-weld process of normalizing heat treatment, which needs to adopt a steel rail post-weld heat treatment device to locally heat the steel rail welded joint, the operation and implementation processes are complex, and the costs are high. It should be noted that the patent relates to a post-weld process of normalizing heat treatment on the steel rail, since the welded area of the steel rail is reheated to a temperature above the austenitizing temperature during the heating process, it is not required to consider the influence of the welding process on the structure performance of the steel rail joint. But the steel rail welded joint needs to be locally heated by the steel rail post-weld heat treatment device, the operation and implementation processes are complex, and the costs are high.

CN103898310A disclosed a post-weld heat treatment method for welded joint of bainite steel rail, the method comprises the following steps: carrying out primary cooling on the to-be-cooled welded joint of the bainite steel rail obtained by welding to a first temperature which is not higher than 450° C., then heating the welded joint subjected to primary cooling to a second temperature, and carrying out secondary cooling, wherein the second temperature is higher than the first temperature and is not higher than 510° C. The method mainly relates to a post-weld heat treatment process of the bainite steel rail welded joint, wherein the starting cooling temperature of the bainite steel rail is 1,300-1,380° C., and the final cooling temperature after the second cooling is room temperature. However, it shall be noted that the bainitic steel rails referred to in the above patent and the hypoeutectoid steel rails referred to in the present disclosure have different composition systems and completely different metallographic structures and mechanical properties and characteristics. In addition, the above patent also involve with the process of post-weld normalizing heat treatment of the steel rail, and requires the steel rail post-weld heat treatment device to carry out local heating and cooling on the welded joint of the steel rail, so that the operation and implementation process is complex, and the costs are high.

Therefore, a post-weld heat treatment method capable of effectively improving the hardness of the longitudinal section of a low-alloy heat treated steel rail welded joint is urgently needed in the technical field of railway engineering, so as to improve the service performance of the steel rail welded joint and ensure operation safety of the railway system.

### SUMMARY

The present disclosure aims to solve the problems in the prior art that the method for heat treating the post-weld steel rail joint has a complex operation process and a high cost, the welded joint after heat treatment has undesirable mechanical property, and physical fatigue life of the steel rail joint is short, and provides post-weld heat treatment method for 1,300 MPa-level low-alloy heat treated steel rail, which has low costs, and desirable mechanical property of the welded joint after the heat treatment, thus the method is suitable for the post-weld heat treatment of the 1300 MPa-level low-alloy heat treated steel rail.

In order to fulfill the above purposes, the present disclosure provides a post-weld heat treatment method for 1,300 MPa-level low-alloy heat treated steel rail, the method comprises the following steps:

(1) subjecting a steel rail welded joint formed by welding and having a residual temperature of 900-1,100° C. to a first stage cooling so as to lower the welded joint surface temperature to 650-720° C., wherein the first stage cooling mode is natural cooling in the air, and the cooling rate is within a range of 4−6° C./s;

(2) subjecting the steel rail welded joint to a second stage cooling so as to lower the welded joint surface temperature to 480-550° C., wherein the second stage cooling adopts a steel rail railhead profiling cooling device for cooling, the cooling medium is compressed air or water mist mixed gas, and the cooling rate is within a range of 2−3.5° C./s;

(3) subjecting the steel rail welded joint to a third stage cooling so as to lower the welded joint surface temperature to 10-30° C., wherein the third stage cooling adopts a steel rail railhead profiling cooling device for cooling, the cooling medium is compressed air or water mist mixed gas, and the cooling rate is within a range of 0.2-0.8° C./s;

wherein a tensile strength of a steel rail base metal of the steel rail welded joint is 1,300 MPa, and the steel rail base metal comprises the following chemical components: 0.75-0.84 wt % of C, 0.6-0.85 wt % of Si, 0.8-1 wt % of Mn, 0.5-0.8 wt % of Cr, ≤0.02 wt % of P, ≤0.02 wt % of S, ≤0.01 wt % of V, the balance of Fe and inevitable impurities.

Preferably, the steel rail welded joint in step (1) is formed by welding with a steel rail mobile flash butt welding machine.

Preferably, a steel rail welded joint formed by welding and having a residual temperature of 1,000-1,080° C. is subjected to a first stage cooling in step (1).

Preferably, a cooling rate of the first-stage cooling in step (1) is within a range of 5.5-6° C./s.

Preferably, the second stage cooling in step (2) is performed with a distance of 18-30 mm between a steel rail railhead profiling cooling device and the steel rail railhead tread.

Preferably, when a pressure of the compressed air or water mist mixed gas ejected from the steel rail railhead profiling cooling device during the second stage cooling in step (2) is within a range of 0.2-0.4 MPa.

Preferably, a cooling rate of the second stage cooling in step (2) is within a range of 2.5-3° C./s.

Preferably, the third stage cooling in step (3) is performed with a distance of 18-30 mm between the steel rail railhead profiling cooling device and the steel rail railhead tread.

Preferably, a pressure of the compressed air or water mist mixed gas ejected from the steel rail railhead profiling cooling device during the third stage cooling in step (3) is within a range of 0.04-0.15 MPa.

More preferably, a pressure of the compressed air or water mist mixed gas ejected from the steel rail railhead profiling cooling device during the third stage cooling in step (3) is within a range of 0.08-0.12 MPa.

Preferably, a cooling rate of the third stage cooling in step (3) is within a range of 0.55-0.6° C./s.

Compared with the prior art, the present disclosure has the following advantages:

(1) The present disclosure carries out heat treatment by taking advantage of the welding waste heat of the steel rail welded joint, and reheating is not needed in the heat treatment process, thereby simplifying the heat treatment process and reducing the costs.

(2) The method can ensure that the longitudinal average hardness of the steel rail joint in the area which is ±20 mm away from the center of the weld seam falls into the range of ±30 HV of the average hardness of the corresponding steel rail base metal (excluding the decarburized weld seam center line, the hardness is low, as the high temperature steel rail welding brings about decarburization of the weld seam center and burning loss of elements), the width of the softening area at both sides of the weld seam of the joint is not more than 15 mm, which can improve “saddle-shaped” abrasion of the steel rail joint caused by low hardness of the welding area during the service process of the steel rail mounted on the rail line. In addition, the percentage content of martensitic structure possibly appearing in the metallographic structure of the welded joint of the steel rail may be controlled within the range of <1%, which is conducive to the control of martensite formed resulting from segregation of the alloy elements. Moreover, the fatigue life of the steel rail joint can reach 3 million times, which is beneficial to ensuring the operation safety of the railway system.

In addition, both the present disclosure and CN110016544A relate to a cooling mode of performing three-step cooling after the flash butt welding of the steel rail. However, it should be noted that the present application is significantly different from CN110016544A, and the specific comparison is shown in Table A.

TABLE A
Comparison of the present application with CN110016544A

| Comparative | Present | | Comparison |
|---|---|---|---|
| items | disclosure | CN110016544A | result |
| Initial | 900-1,100° C. | 1,100-1,400° C. | Without |
| temperature | | | significant |
| | | | difference |
| First | The | The | The cooling |
| cooling | temperature | temperature | rate is |
| temperature | is 650-720° C., | is 550-750° C., | different |
| and | the cooling rate | the cooling rate | |
| cooling | is 4-6° C./s | is 3.0-5.0° C./s | |
| rate | | | |
| Second | The | The | The |
| cooling | temperature | temperature | temperature |
| temperature | is 480-550° C., | is 290-400° C., | ranges are |
| and | the cooling | the cooling | different |
| cooling | rate is 2- | rate | |
| rate | 3.5° C./s | is 1.5-2.5° | |
| | | C./s | |
| Third | Room | Room | The cooling |
| cooling | temperature, | temperature, | rates are |
| temperature | the cooling | the air cooling | different |
| and | rate is 0.2- | rate is 0.05- | |
| cooling | 0.8° C./s | 0.5° C./s | |
| rate | | | |
| Implemen- | The percentage | The longitudinal | The |
| tation | content of | hardness of the | implemen- |
| effects | martensitic | bainite steel | tation |
| | structure possibly | rail joint in a | effects are |
| | appearing in the | area which is ±25 | different |
| | metallographic | mm away from | |
| | structure of the | the center of a | |
| | steel rail joint is | weld seam is | |
| | controlled within | controlled | |
| | the range of ≤1%, | to be 80-85% of | |
| | and the fatigue life | that of a base | |
| | of the steel rail | metal, and the | |
| | joint may reach | widths of | |
| | 3 million times. | softening regions | |
| | | at two sides of | |
| | | the weld seam are | |
| | | both lower than | |
| | | 20.0 mm; the | |
| | | physical fatigue | |
| | | life of the | |
| | | joint is not less | |
| | | than 2.50 million | |
| | | times, which is | |
| | | higher than | |
| | | 2 million times | |
| | | specified by the | |
| | | railway industry | |
| | | standards | |
| | | TB/T1632.2-2014 | |
| | | and TB/T 1632.4- | |
| | | 2014, and the | |
| | | percentage | |
| | | content of | |
| | | martensite is | |
| | | controlled to | |
| | | be ≤5%. | |
| Applicable | A flash welded | A rail flash | The steel rail |
| objects | joint of a low- | welding joint of | base metals |
| | alloy heat | bainite steel. | have different |
| | treated steel | The chemical | chemical |
| | rail. The steel | components of the | components, |
| | rail base | steel rail base | the steel rails |
| | metal comprise | material comprise: | have different |
| | the following | 0.15-0.30% of C, | metallographic |
| | chemical | 1.0-1.8% of Si, | structures, |
| | components: | 1.5-2.5% of Mn, | materials and |
| | 0.75-0.84 wt % | 0.2-0.6% of Cr, | mechanical |
| | of C, 0.6-0.85 wt % | 0.05-0.10% of | properties. |
| | of Si, 0.8-1 wt % | Mo, ≤0.005% | |
| | of Mn, 0.5-0.8 wt % | of Al, ≤0.01% of | |
| | of Cr, ≤0.02 wt % | P and S. | |
| | of P, ≤0.02 wt % | | |
| | of S, ≤0.01 wt % | | |
| | of V, the balance | | |
| | of Fe and | | |
| | inevitable | | |
| | impurities. | | |

The results in Table A show that both the present disclosure and CN110016544A relate to the processes for performing heat treatment on the steel rail joint with high welding residual temperature by using the welding residual heat as the heat source, but the rail joints have various microstructure changes and properties due to different materials of the steel rails and different cooling processes, that is, the implementation effects are different. Therefore, the present disclosure is significantly different from CN 110016544A.

### BRIEF DESCRIPTION OF THE DRAWINGS

FIG. 1 is a graph showing the effect of longitudinal hardness at a position of 3-5 mm below the railhead tread of a low-alloy heat treated steel rail welded joint under the post-weld heat treatment condition obtained with the method of Example 1;

FIG. 2 is a graph showing the effect of longitudinal hardness at a position of 3-5 mm below the railhead tread of a low-alloy heat treated steel rail welded joint under the post-weld heat treatment condition obtained with the method of Example 2;

FIG. 3 is a graph showing the effect of longitudinal hardness at a position of 3-5 mm below the railhead tread of a low-alloy heat treated steel rail welded joint under the post-weld heat treatment condition obtained with the method of Comparative Example 1;

FIG. 4 is a graph showing the effect of longitudinal hardness at a position of 3-5 mm below the railhead tread of a low-alloy heat treated steel rail welded joint under the post-weld heat treatment condition obtained with the method of Comparative Example 2;

FIG. 5 is a graph showing the effect of longitudinal hardness at a position of 3-5 mm below the railhead tread of a low-alloy heat treated steel rail welded joint under the post-weld heat treatment condition obtained with the method of Comparative Example 3;

FIG. 6 is a graph showing the effect of longitudinal hardness at a position of 3-5 mm below the railhead tread of a low-alloy heat treated steel rail welded joint under the post-weld heat treatment condition obtained with the method of Comparative Example 4;

FIG. 7 is a graph showing the effect of longitudinal hardness at a position of 3-5 mm below the railhead tread of a low-alloy heat treated steel rail welded joint under the post-weld heat treatment condition obtained with the method of Comparative Example 5;

FIG. 8 illustrates a schematic diagram showing the position of a longitudinal hardness detection point at a position of 3-5 mm below a railhead tread of the steel rail welded joint according to the present disclosure;

FIG. 9 illustrates a schematic view of a metallographic specimen sampling position of a railhead tread of the steel rail welded joint according to the present disclosure;

FIG. 10 illustrates a schematic view of the steel rail railhead profiling cooling device used in the present disclosure;

FIG. 11 illustrates a schematic view of the bottom of the steel rail railhead profiling cooling device used in the present disclosure.

### DESCRIPTION OF REFERENCE SIGNS

1. Medium channel;
2. Top nozzle;
3. Medium channel;
4. Side nozzle;
a. Recrystallization region;
b. Railhead tread;
c. Weld seam;
d. Inspection surface of the metallographic test.

### DETAILED DESCRIPTION

The following content describes in detail the embodiments of the present disclosure with reference to the appended drawings. It should be comprehended that the specific embodiments described herein merely serve to illustrate and explain the present disclosure, instead of imposing limitation thereto.

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point values of the various ranges, and the individual point values may be combined with one another to produce one or more new numerical ranges, which should be deemed have been specifically disclosed herein.

The inventors have found in the previous researches that the critical cooling rate of martensite transformation in the continuous cooling transformation process of 1,300 MPa-level low-alloy heat treated steel rail involved in the present disclosure is 1.0-2.0° C./s, and the Ms temperature (the starting temperature of forming the martensitic structure) is 170-220° C. In order to avoid the occurrence of abnormal structures such as martensite and bainite in a steel rail welded joint, when the steel rail welded joint is subjected to post-weld heat treatment, it is required to control the final cooling temperature in the rapid cooling process of the post-weld heat treatment of the steel rail to be higher than the Ms temperature of the steel rail. Wherein it comprises the steps of subjecting the steel rail joint with a temperature above the austenitizing temperature to a rapid cooling with a cooling rate higher than the critical cooling rate of the martensite transformation of the steel rail, and controlling the final cooling temperature to be higher than the Ms temperature of the steel rail, and controlling the subsequent cooling rate to be lower than the critical cooling rate of the martensite transformation of the steel rail. Otherwise, the joint will experience premature fatigue fracture due to a large amount of quenching and hardening martensite. Under the premise of not considering the component segregation, when subjecting the steel rail joint with a temperature above the austenitizing temperature to a rapid cooling to a temperature below the Ms temperature with a cooling rate lower than the critical cooling rate of the martensite transformation of the steel rail, martensite is not formed in the steel rail joint. Thus, it is stipulated in the steel rail welding standards such as the Australian steel rail welding standard AS 1085.20-2012 that in regard to some steel rails with high strength grade, high carbon content and high alloy content, under the 100× observation magnification of a metallographic microscope, the percentage content of a martensitic structure in the most serious area with the occurrence of martensite of a steel rail welded joint shall not higher than 5%, otherwise the joint may suffer from an premature fatigue fracture due to a large amount of quenched and hardened martensite, the operation safety of the railway line is seriously influenced. Therefore, the strict control of the martensite content in the steel rail welded structure is crucial to stable operation of the railway line. Based on the above findings, the inventors have completed the present disclosure.

It should be noted that the thickness of the rail web and rail base is relatively thin, their temperature drops during the cooling process are relatively fast, thus the martensite is prone to form when the cooling rate of heat treatment is not properly controlled. Moreover, the rail web area is usually the area with the most serious segregation of the steel rail, and the martensitic structure is most easily formed in the rail web. For the sake of avoiding deterioration of the service performance of the steel rail welded joint caused by an existence of a large amount of brittle and hardened martensitic structures, the post-weld heat treatment of the steel rail is only carried out in regard to the railhead tread of the steel rail joint and the side face of the railhead adjacent to the railhead tread, while the rail web and the rail bottom of the steel rail joint are subjected to the natural cooling.

The present disclosure provides a post-weld heat treatment method for 1,300 MPa-level low-alloy heat treated steel rail, the method comprises the following steps:

(1) subjecting a steel rail welded joint formed by welding and having a residual temperature of 900-1,100° C. to a first stage cooling so as to lower the welded joint surface temperature to 650-720° C., wherein the first stage cooling mode is natural cooling in the air, and the cooling rate is within a range of 4-6° C./s;

(2) subjecting the steel rail welded joint to a second stage cooling so as to lower the welded joint surface temperature to 480-550° C., wherein the second stage cooling adopts a steel rail railhead profiling cooling device for cooling, the cooling medium is compressed air or water mist mixed gas, and the cooling rate is within a range of 2-3.5° C./s;

(3) subjecting the steel rail welded joint to a third stage cooling so as to lower the welded joint surface temperature to 10-30° C., wherein the third stage cooling adopts a steel rail railhead profiling cooling device for cooling, the cooling medium is compressed air or water mist mixed gas, and the cooling rate is within a range of 0.2-0.8° C./s.

In the present disclosure, the tensile strength of a steel rail base metal of the steel rail welded joint is 1,300 MPa, the steel rail base metal comprise the following chemical components: 0.75-0.84 wt % of C, 0.6-0.85 wt % of Si, 0.8-1 wt % of Mn, 0.5-0.8 wt % of Cr, ≤0.02 wt % of P, ≤0.02 wt % of S, ≤0.01 wt % of V, the balance of Fe and inevitable impurities.

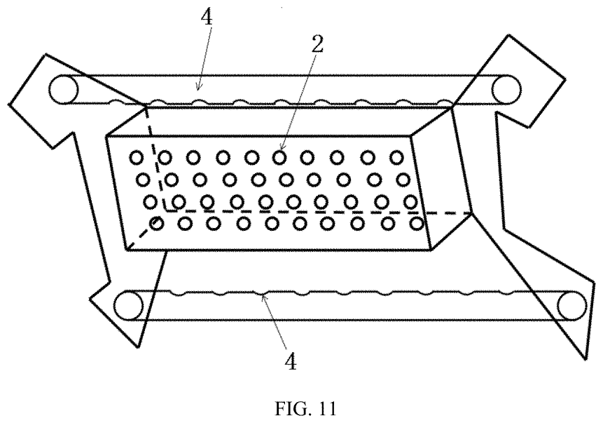

In the method of the present disclosure, the configuration of the steel rail railhead profiling cooling device described in step (2) and step (3) is as shown in FIG. 10 and FIG. 11, wherein the steel rail railhead profiling cooling device comprises a medium channel 1, a top nozzle 2, a medium channel 3 and a side nozzle 4, wherein the medium channel 1 is connected with the top nozzle 2, and the medium channel 3 is connected with the side nozzle 4. The device only carries out cooling in regard to the steel rail railhead tread and the side face of the railhead, the shape and size of the apertures of the device can be designed, processed and modified according to the practical requirements, so as to provide different cooling intensities. The pressure of the medium flowing through the medium channels 1 and 3 can be monitored by means of the relevant pressure detection device, and the medium pressure is adjustable in line with the actual requirements.

According to the present disclosure, an infrared thermometer is adopted to collect temperature signals of the steel rail railhead tread, wherein the steel rail railhead tread is a contact part of the train wheels and the steel rail; the hardness value corresponding to the softening area width measuring line in the longitudinal hardness curve of the steel rail joint is the hardness obtained by subtracting 25HV from the average hardness Hp of the steel rail base metal; the width of the softened region in the hardness curve is the intercept of the hardness curve with a measurement line of the width of the softened region.

In the present disclosure, unless otherwise stated, the term “steel rail welded joint” refers to a welded region having a length of 60-80 mm and including a weld seam and/or a heat-affected zone (HAZ), the center of the region is the weld seam of the steel rail.

The method of the present disclosure carries out heat treatment on the 1,300 MPa-level low alloy heat treatment steel rail welded joint, and the method adopts a cooling process consisting of three stages to treat the welded joint, lowers the surface temperature of the steel rail welded joint in each stage of the cooling process to an appropriate temperature, reasonably controls the cooling rate in each stage of cooling process, and adopts a suitable cooling device and a proper cooling mode, thereby effectively improving the hardness of the longitudinal section of the low alloy heat treatment steel rail welded joint, improving the service performance of the steel rail welded joint, and ensuring operation safety of the railway line.

The present disclosure served to perform the post-weld rapid cooling in regard to the steel rail joint having a high welding residual temperature, so as to reduce the transformation temperature of the joint railhead from austenite to pearlite, and improve hardness of an austenite recrystallization region. Based on the principle of metallurgy, a steel rail joint has a certain dynamic supercooling degree under the condition of rapid cooling from the high-temperature after welding, so that the phase transition temperature of the transformation from austenite to pearlite in a non-equilibrium state moves downwards, and the phase transition temperature is gradually reduced along with an increase of the supercooling degree. It should be noted that the temperature measurement process of the infrared thermometer is only performed on the surface of the steal rail railhead tread, the temperature of the rail core is usually 50-80° C. higher than that of the surface. Even if the rail surface temperature is below the phase transition temperature, the phase transition process can still occur due to the higher core temperature. Therefore, even if the joint railhead is cooled in the second stage with a relative low starting cooling temperature, the structural transformation from austenite to pearlite can still happen. In the present disclosure, the first cooling refers to a natural cooling in air, the control of the cooling rate in the first stage can be implemented by adjusting an ambient temperature of the test (such as controlling the temperature by adopting a central air-conditioning system), and the final cooling temperature of the first cooling of the steel rail welded joint can be controlled at 650-720° C. by adjusting the setting of a welding machine or performing the manual operation. The starting cooling temperature of the second cooling is 650-720° C. In the present disclosure, the final cooling temperature of the second cooling is 480-550° C., which is above the Ms temperature of the steel rail. When the steel rail joint is subjected to the third stage cooling, in order to avoid an occurrence of a large amount of quenched and hardened martensite in the steel rail joint, the present disclosure selects to cool the steel rail joint with the cooling rate of 0.2-0.8° C./s, which is lower than the critical cooling rate of martensite transformation of the steel rail steel.

According to the metallurgical principle, the martensitic structure in the steel is a product of cooling the steel having a temperature above the austenitizing temperature at a cooling rate higher than the critical cooling rate of the martensite transformation to a temperature below the Ms temperature (the starting temperature of formation the martensitic structure). In order to avoid the generation of a large amount of brittle and hardened martensite in the steel rail joint, when the steel rail joint is subjected to post-weld heat treatment, the final cooling temperature in the post-weld heat treatment rapid cooling process is controlled to be higher than the Ms temperature of the steel rail in the second cooling stage. When the joint is subjected to heat treatment in the second cooling stage at a cooling rate higher than the critical cooling rate of forming the martensite of the steel rail, the final cooling temperature of the stage is higher than the Ms temperature of the rail steel, and the cooling rate of the third cooling stage is lower than the critical cooling rate of forming martensite in the steel rail. Although the element segregation is unavoidable in the steel rail welding process, only a small amount of martensite is generated due to the high final cooling temperature in the post-weld heat treatment cooling process; when the percentage content of the martensite is lower than 5% and the martensite is in a dispersion distribution (under the 100× observation condition of a metallographic microscope), the fatigue life of a steel rail joint will not be obviously influenced. Meanwhile, the cooling rate of the second cooling stage of the post-weld heat treatment is relatively high, the high supercooling degree is beneficial to improving the toughness of the joint, so that the steel rail joint of the present disclosure has a long fatigue life.

In a preferred embodiment, the steel rail welded joint in step (1) is formed by welding with a steel rail mobile flash welding machine.

The present disclosure carries out heat treatment by utilizing the welding waste heat of the welded joint. In a specific embodiment, the steel rail welded joint with the residual temperature of 900° C., 920° C., 940° C., 960° C., 980° C., 1,000° C., 1,020° C., 1,040° C., 1,060° C., 1,080° C. or 1,100° C. is subjected to first-stage cooling in step (1).

In a preferred embodiment, the steel rail welded joint formed by welding and having a residual temperature of 1,000-1,080° C. is subjected to a first stage cooling in step (1).

In the method of the present disclosure, the cooling temperature and the cooling rate during each stage cooling need to be reasonably controlled, such that the hardness of the longitudinal section of the 1,300 MPa-level low-alloy heat treated steel rail welded joint is improved, the percentage content of martensitic structures possibly appearing in the metallographic structure of the steel rail welded joint can be controlled within the range of <1%, and the fatigue life of the steel rail joint reaches 3 million times.

In a preferred embodiment, the welded joint surface temperature after the first stage cooling in step (1) may be lowered to 650° C., 660° C., 670° C., 680° C., 690° C., 700° C., 710° C., 720° C., or any value within the range consisting of any two of the point values.

In a preferred embodiment, the welded joint surface temperature is lowered to 680-710° C. after the first stage cooling in step (1).

In a specific embodiment, the cooling rate of the first stage cooling in step (1) may be 4° C./s, 4.2° C./s, 4.4° C./s, 4.6° C./s, 4.8° C./s, 5° C./s, 5.2° C./s, 5.4° C./s, 5.6° C./s, 5.8° C./s, or 6° C./s.

In a preferred embodiment, the cooling rate of the first stage cooling in step (1) is within a range of 5.5-6° C./s.

In the method of the present disclosure, the welded joint surface temperature after the second stage cooling in step (2) may be lowered to 480° C., 490° C., 500° C., 510° C., 520° C., 530° C., 540° C., 550° C., or any value within the range consisting of any two of the point values.

In the method of the present disclosure, when the second stage cooling is carried out in the step (2), the distance between the steel rail railhead profiling cooling device and the steel rail railhead tread is within a range of 18-30 mm; specifically, for example, the distance may be 18 mm, 20 mm, 22 mm, 24 mm, 26 mm, 28 mm, 30 mm, or any value within the range consisting of any two of the point values; preferably, when the second stage cooling is carried out in the step (2), the distance between the steel rail railhead profiling cooling device and the steel rail railhead tread is within a range of 25-30 mm.

In the method of the present disclosure, when the second stage cooling is carried out in the step (2), the pressure of the compressed air or water mist mixed gas ejected from the steel rail railhead profiling cooling device is within a range of 0.2-0.4 MPa; specifically, for example, the pressure may be 0.2 MPa, 0.22 MPa, 0.24 MPa, 0.26 MPa, 0.28 MPa, 0.3 MPa, 0.32 MPa, 0.34 MPa, 0.36 MPa, 0.38 MPa, 0.4 MPa, and any value within the range consisting of any two of the point values; preferably, when the second stage cooling is carried out in the step (2), the pressure of the compressed air or water mist mixed gas ejected from the steel rail railhead profiling cooling device is 0.3 MPa.

In a specific embodiment, the cooling rate in step (2) may be 2° C./s, 2.3° C./s, 2.5° C./s, 2.7° C./s, 3° C./s, 3.2° C./s, or 3.5° C./s.

In a preferred embodiment, a cooling rate of the second stage cooling in step (2) is within a range of 2.5-3° C./s.

In a specific embodiment, when the steel rail welded joint is subjected to a third stage cooling in step (3), the welded joint surface temperature may be lowered to 10° C., 14° C., 18° C., 22° C., 24° C., 26° C. or 30° C.

In a preferred embodiment, when the steel rail welded joint is subjected to the third stage cooling in step (3), the surface temperature of the steel rail welded joint is reduced to 20-25° C.

In the method of the resent disclosure, when the third stage cooling in step (3) is performed, the distance between the steel rail railhead profiling cooling device and the steel rail railhead tread is within a range of 18-30 mm; specifically, the distance may be 18 mm, 20 mm, 22 mm, 24 mm, 26 mm, 28 mm or 30 mm, for example.

In the method of the present disclosure, when the third stage cooling in step (3) is performed, the pressure of the compressed air or water mist mixed gas ejected from the steel rail railhead profiling cooling device is within a range of 0.04-0.15 MPa; specifically, the pressure may be 0.04 MPa, 0.06 MPa, 0.08 MPa, 0.1 MPa, 0.12 MPa, 0.14 MPa or 0.15 MPa, for example; preferably, when the third stage cooling in step (3) is performed, the pressure of the compressed air or water mist mixed gas ejected from the steel rail railhead profiling cooling device is within a range of 0.08-0.12 MPa.

In a specific embodiment, the cooling rate of the third-stage cooling in step (3) may be 2° C./s, 2.3° C./s, 2.5° C./s, 2.8° C./s, 3° C./s, 3.2° C./s, 3.5° C./s, or any value within the range consisting of any two of the point values.

In a preferred embodiment, the cooling rate of the third-stage cooling in step (3) is within a range of 0.55-0.6° C./s.

In regard to the present disclosure, it should be noted that the heat treatment technique is a process for controlling factors during the heating and cooling processes, the steps in the heat treatment technique correlate with each other and impacts on each other. The present application may have unavoidable process parameter coincidence with other patent documents, but the patents have different applicable objects, devices for performing heat treatment, so that the data cannot be mechanically applied and simply compared. It is inevitable that the chemical components of the steel rails, heat treatment process and the like developed in various countries in the world have some overlaps, and are influenced by factors such as smelting capacity, heat treatment equipment, personnel operation level, the applicable objects (including the mechanical property and the temperature distribution of the steel rails) of the invention patents are different, the adopted cooling devices and the implementation processes are different, such that the essential difference is generated, the processes cannot be simply and mechanically applied. In addition, the present disclosure adopts a three-step cooling mode (post-weld normalizing heat treatment is not needed) according to the continuous cooling characteristic of the low-alloy heat treated steel rail, limits the cooling rate and the cooling temperature of each cooling stage, thereby improving the “saddle-shaped” abrasion of a steel rail joint caused by low hardness of a welded area during the service process of a steel rail on the rail line, as a result, the present application represents a notable progress compared with other patent applications.

The present disclosure will be described in detail with reference to examples, but the protection scope of the present disclosure is not limited thereto.

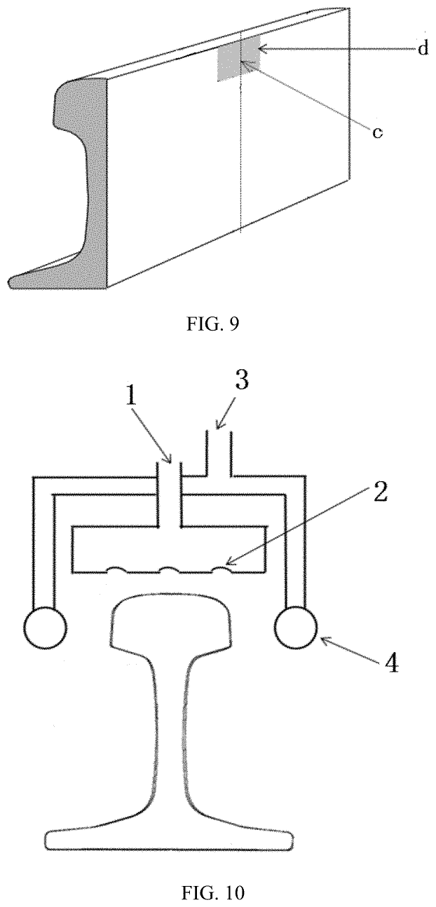

In the examples and comparative examples of the present disclosure, FIG. 9 illustrated the metallographic specimen sampling position of a railhead tread of the steel rail welded joint. FIG. 8 illustrated the position of a longitudinal hardness detection point at a position of 3-5 mm below a railhead tread of the steel rail welded joint, wherein the reference sign “a” denoted a recrystallization region; the reference sign “b” denoted a railhead tread; the reference sign “c” denoted a weld seam; the reference sign “d” denoted an inspection surface of the metallographic test.

According to the present disclosure, the specification of the 1,300 MPa-level low-alloy heat treated steel rails used for welding was 60-75 kg/m, and the steel rail welded joint was the welded joint formed by a steel rail mobile flash welding machine by adopting the same welding process.

The present disclosure adopted a pulse bending fatigue test. The load frequency was 5 Hz, and the load ratio was 0.2. The maximum load and the minimum load were determined according to the railway industry standard TB/T1632.1-2014. A three-point bending fatigue test was carried out on a steel rail welded joint by adopting a MTS-FT310 fatigue testing machine, the test target was that the welded joint did not generate fatigue fracture after imposing the cyclic load for 3 million times.

### Example 1

After the steel rail with a specification of 68 kg/m had subjected to the upsetting and removal of the weld collar during the mobile flash welding process, the welded joint was subjected to the post-weld heat treatment. Firstly, the steel rail welded joint formed by welding and having a residual temperature of 1,080° C. was subjected to a first stage cooling at a first cooling rate of 5.5° C./s, so as to lower the railhead surface temperature of the steel rail joint to 710° C.; the steel rail joint was then subjected to a second stage cooling at a second cooling rate of 2.2° C./s, so as to lower the railhead surface temperature of the steel rail joint to 530° C.; the steel rail joint was finally subjected to a third stage cooling at a third cooling rate of 0.55° C./s, so as to lower the railhead surface temperature of the steel rail joint to the room temperature of 25° C.; such that the steel rail welded joint after the post-weld heat treatment was obtained. During the post-weld heat treatment process, the first stage cooling was natural cooling in the air; a steel rail railhead profiling cooling device was used in the second stage cooling and the third stage cooling, wherein the compressed air was used as a cooling medium to cool the railhead tread and the railhead side face of a steel rail joint; the distance between the cooling device and the steel rail railhead tread was 30 mm; the gas pressure of the compressed air ejected from the cooling device during the second stage cooling process was 0.3 MPa; the gas pressure of the compressed air ejected from the cooling device during the third stage cooling process was 0.08 MPa. An infrared thermometer was used for monitoring the temperature of the steel rail railhead tread.

The steel rail joint after the post-weld heat treatment obtained from the example was machined into a longitudinal hardness test sample. A Brinell and Vickers hardness tester (model HBV-30A, manufactured by the Laizhou Testing Machine General Factory in Shandong Province) was used for performing the longitudinal Vickers hardness detection on the hardness test sample at a position 4 mm below the steel rail railhead tread by taking 2 mm as the measuring point interval, the measuring points were symmetrically arranged towards the left side and the right side by taking the weld seam as a center. The Vickers hardness test method was performed with reference to the national standard GB/T4340.1-2009 “Metal Vickers Hardness Testing Part 1: experimental methods” and using the HV scale. The hardness test data were illustrated in Table 1, and the distribution effect of the longitudinal hardness of the joints was shown in FIG. 1.

TABLE 1
Distance from the weld seam center/mm

| | | | | | | | | | | | | |
|---|---|---|---|---|---|---|---|---|---|---|---|---|
| Left | Distance | 0 | 2 | 4 | 6 | 8 | 10 | 12 | 14 | 16 | 18 | 20 |
| side | from the | | | | | | | | | | | |
| | weld seam | | | | | | | | | | | |
| | Hardness/HV | 380 | 432 | 430 | 429 | 425 | 416 | 360 | 334 | 368 | 398 | 413 |
| | Distance | 22 | 24 | 26 | 28 | 30 | 32 | 34 | 36 | 38 | 40 | / |
| | from the | | | | | | | | | | | |
| | weld seam | | | | | | | | | | | |
| | Hardness/HV | 422 | 428 | 429 | 432 | 432 | 431 | 432 | 430 | 431 | 431 | / |
| Right | Distance | 0 | 2 | 4 | 6 | 8 | 10 | 12 | 14 | 16 | 18 | 20 |
| side | from the | | | | | | | | | | | |
| | weld seam | | | | | | | | | | | |
| | Hardness/HV | 380 | 433 | 431 | 432 | 427 | 420 | 362 | 336 | 370 | 400 | 416 |
| | Distance | 22 | 24 | 26 | 28 | 30 | 32 | 34 | 36 | 38 | 40 | / |
| | from the | | | | | | | | | | | |
| | weld seam | | | | | | | | | | | |
| | Hardness/HV | 418 | 430 | 430 | 431 | 432 | 430 | 431 | 432 | 433 | 432 | / |

As indicated by the Table 1 and FIG. 1, the average hardness of the base material was 431 HV. In regard to the steel rail welded joint treated with the method of the present disclosure, the longitudinal average hardness of the steel rail joint in the area being ±20 mm away from the weld seam center was 402HV, which satisfied the range of ±30 HV of the average hardness of the steel rail base metal (excluding the decarburized weld seam center line: the hardness was low, as the high temperature steel rail welding brought about decarburization of the weld seam center and burning loss of elements). The width of the softened area on the left side of the joint weld seam was 9.0 mm, the width of the softened area on the right side of the joint weld seam was 9.0 mm, each of the widths of the softened areas on the both sides of the joint weld seam was not more than 15.0 mm.

With reference to the sampling method shown in FIG. 9, the metallographic structure examination was performed on the metallographic structure sample of the steel rail joint according to the national standard GB/T13298-2015 “Metal Microstructure Examination Method”, the metallographic sample of the steel rail joint was subjected to etching with the nitric acid alcohol solution having a concentration of 3%, and the metallographic structure of the steel rail joint was observed with the German Leica MeF3 optical microscope. The result showed that under the observation magnification 100× of the metallographic microscope, statistic data showed that only a small amount of punctiform martensite was produced in the region with the most severe presence of martensite in the heat affected zone of the joint, and the percentage content of the martensite was only 0.5%. In addition, the fatigue life of the steel rail joint may reach 3 million times, which was beneficial to ensuring operation safety of the railway line.

### Example 2

After the steel rail with a specification of 60 kg/m had subjected to the upsetting and removal of the weld collar during the mobile flash welding process, the welded joint was subjected to the post-weld heat treatment. Firstly, the steel rail welded joint formed by welding and having a residual temperature of 1,000° C. was subjected to a first stage cooling at a first cooling rate of 5.8° C./s, so as to lower the railhead surface temperature of the steel rail joint to 680° C.; the steel rail joint was then subjected to a second stage cooling at a second cooling rate of 2.5° C./s, so as to lower the railhead surface temperature of the steel rail joint to 490° C.; the steel rail joint was finally subjected to a third stage cooling at a third cooling rate of 0.6° C./s, so as to lower the railhead surface temperature of the steel rail joint to the room temperature of 25° C.; such that the steel rail welded joint after the post-weld heat treatment was obtained. During the post-weld heat treatment process, the first stage cooling was natural cooling in the air; a steel rail railhead profiling cooling device was used in the second stage cooling and the third stage cooling, wherein the compressed air was used as a cooling medium to cool the railhead tread and the railhead side face of a steel rail joint; the distance between the cooling device and the steel rail railhead tread was 30 mm; the gas pressure of the compressed air ejected from the cooling device during the second stage cooling process was 0.3 MPa; the gas pressure of the compressed air ejected from the cooling device during the third stage cooling process was 0.1 MPa. An infrared thermometer was used for monitoring the temperature of the steel rail railhead tread.

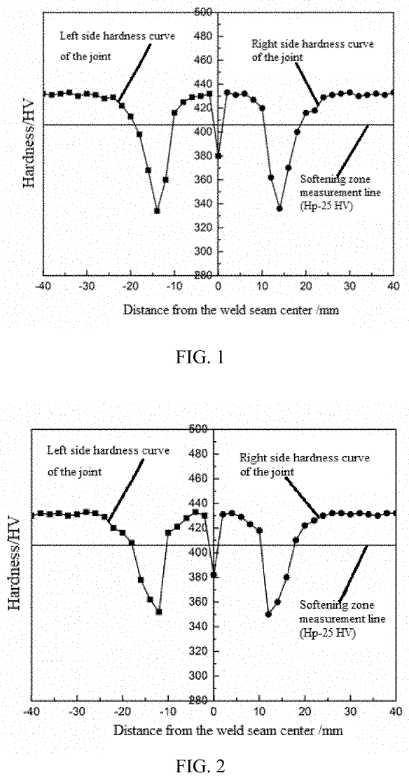

The steel rail joint after the post-weld heat treatment obtained from the example was machined into a longitudinal hardness test sample. A Brinell and Vickers hardness tester (model HBV-30A, manufactured by the Laizhou Testing Machine General Factory in Shandong Province) was used for performing the longitudinal Vickers hardness detection on the hardness test sample at a position 4 mm below the steel rail railhead tread by taking 2 mm as the measuring point interval, the measuring points were symmetrically arranged towards the left side and the right side by taking the weld seam as a center. The Vickers hardness test method was performed with reference to the national standard GB/T4340.1-2009 “Metal Vickers Hardness Testing Part 1: experimental methods” and using the HV scale. The hardness test data were illustrated in Table 2, and the distribution effect of the longitudinal hardness of the joints was shown in FIG. 2.

TABLE 2
Distance from the weld seam center/mm

| | | | | | | | | | | | | |
|---|---|---|---|---|---|---|---|---|---|---|---|---|
| Left | Distance | 0 | 2 | 4 | 6 | 8 | 10 | 12 | 14 | 16 | 18 | 20 |
| side | from the | | | | | | | | | | | |
| | weld seam | | | | | | | | | | | |
| | Hardness/HV | 380 | 432 | 430 | 429 | 426 | 416 | 360 | 334 | 368 | 398 | 413 |
| | Distance | 22 | 24 | 26 | 28 | 30 | 32 | 34 | 36 | 38 | 40 | / |
| | from the | | | | | | | | | | | |
| | weld seam | | | | | | | | | | | |
| | Hardness/HV | 422 | 429 | 428 | 431 | 431 | 430 | 432 | 431 | 430 | 432 | / |
| Right | Distance | 0 | 2 | 4 | 6 | 8 | 10 | 12 | 14 | 16 | 18 | 20 |
| side | from the | | | | | | | | | | | |
| | weld seam | | | | | | | | | | | |
| | Hardness/HV | 380 | 433 | 431 | 432 | 427 | 420 | 362 | 336 | 370 | 400 | 416 |
| | Distance | 22 | 24 | 26 | 28 | 30 | 32 | 34 | 36 | 38 | 40 | / |
| | from the | | | | | | | | | | | |
| | weld seam | | | | | | | | | | | |
| | Hardness/HV | 418 | 429 | 431 | 432 | 433 | 430 | 431 | 432 | 431 | 432 | / |

As indicated by the Table 2 and FIG. 2, the average hardness of the base material was 431 HV. In regard to the steel rail welded joint treated with the method of the present disclosure, the longitudinal average hardness of the steel rail joint in the area being ±20 mm away from the weld seam center was 405HV, which satisfied the range of ±30 HV of the average hardness of the steel rail base metal (excluding the decarburized weld seam center line, the hardness was low, as the high temperature steel rail welding brought about decarburization of the weld seam center and burning loss of elements). The width of the softened area on the left side of the joint weld seam was 8.0 mm, the width of the softened area on the right side of the joint weld seam was 8.0 mm, each of the widths of the softened areas on the both sides of the joint weld seam was not more than 15.0 mm.

With reference to the sampling method shown in FIG. 9, the metallographic structure examination was performed on the metallographic structure sample of the steel rail joint according to the national standard GB/T13298-2015 “Metal Microstructure Examination Method”, the metallographic sample of the steel rail joint was subjected to etching with the nitric acid alcohol solution having a concentration of 3%, and the metallographic structure of the steel rail joint was observed with the German Leica MeF3 optical microscope. The result showed that under the observation magnification 100× of the metallographic microscope, statistic data showed that only a small amount of punctiform martensite was produced in the region with the most severe presence of martensite in the heat affected zone of the joint, and the percentage content of the martensite was only 0.7%. In addition, the fatigue life of the steel rail joint may reach 3 million times, which was beneficial to ensuring operation safety of the railway line.

### Comparative Example 1

After the steel rail with a specification of 68 kg/m had subjected to the upsetting and removal of the weld collar during the mobile flash welding process, the steel rail joint with the residual temperature of 1100° C. was directly subjected to the air cooling to the room temperature (about 25° C.), such that the steel rail welded joint under the condition of air cooling (natural cooling) was obtained.

The steel rail joint obtained after welding and under the condition of air cooling from the comparative example was machined into a longitudinal hardness test sample. A Brinell and Vickers hardness tester (model HBV-30A, manufactured by the Laizhou Testing Machine General Factory in Shandong Province) was used for performing the longitudinal Vickers hardness detection on the hardness test sample at a position 5 mm below the steel rail railhead tread by taking 2 mm as the measuring point interval, the measuring points were symmetrically arranged towards the left side and the right side by taking the weld seam as a center. The Vickers hardness test method was performed with reference to the national standard GB/T4340.1-2009 “Metal Vickers Hardness Testing Part 1: experimental methods” and using the HV scale. The hardness test data were illustrated in Table 3, and the distribution effect of the longitudinal hardness of the joints was shown in FIG. 3.

TABLE 3
Distance from the weld seam center/mm

| | | | | | | | | | | | | |
|---|---|---|---|---|---|---|---|---|---|---|---|---|
| Left | Distance | 0 | 2 | 4 | 6 | 8 | 10 | 12 | 14 | 16 | 18 | 20 |
| side | from the | | | | | | | | | | | |
| | weld seam | | | | | | | | | | | |
| | Hardness/HV | 365 | 390 | 393 | 395 | 385 | 333 | 312 | 370 | 398 | 411 | 416 |
| | Distance | 22 | 24 | 26 | 28 | 30 | 32 | 34 | 36 | 38 | 40 | / |
| | from the | | | | | | | | | | | |
| | weld seam | | | | | | | | | | | |
| | Hardness/HV | 420 | 426 | 427 | 429 | 429 | 430 | 430 | 432 | 431 | 431 | / |
| Right | Distance | 0 | 2 | 4 | 6 | 8 | 10 | 12 | 14 | 16 | 18 | 20 |
| side | from the | | | | | | | | | | | |
| | weld seam | | | | | | | | | | | |
| | Hardness/HV | 365 | 393 | 390 | 380 | 370 | 320 | 310 | 330 | 380 | 416 | 421 |
| | Distance | 22 | 24 | 26 | 28 | 30 | 32 | 34 | 36 | 38 | 40 | / |
| | from the | | | | | | | | | | | |
| | weld seam | | | | | | | | | | | |
| | Hardness/HV | 425 | 423 | 425 | 431 | 430 | 433 | 432 | 433 | 432 | 431 | / |

As indicated by the Table 3 and FIG. 3, the average hardness of the base material was 431 HV. In regard to the steel rail welded joint without being treated with the method of the present disclosure, the whole welding area was in a softening state as compared with the hardness of the steel rail base metal at both sides of the weld seam. The longitudinal average hardness of the steel rail joint in the area being ±20 mm away from the weld seam center was 375HV, which cannot satisfy the range of ±30 HV of the average hardness of the steel rail base metal (excluding the decarburized weld seam center line, the hardness was low, as the high temperature steel rail welding brought about decarburization of the weld seam center and burning loss of elements). The width of the softened area on the left side of the joint weld seam was 18.0 mm, the width of the softened area on the right side of the joint weld seam was 18.0 mm. During the service process of the welded joint in the railway line, the welded joint obtained by the comparative example was prone to form a collapse of the steel rail railhead tread in a softening area of the steel joint, which caused a “saddle-shaped” abrasion, influenced smoothness of the railway line and safety of the moving trains.

With reference to the sampling method shown in FIG. 9, the metallographic structure examination was performed on the metallographic structure sample of the steel rail joint according to the national standard GB/T13298-2015 “Metal Microstructure Examination Method”, the metallographic sample of the steel rail joint was subjected to etching with the nitric acid alcohol solution having a concentration of 3%, and the metallographic structure of the steel rail joint was observed with the German Leica MeF3 optical microscope. The result showed that the metallographic structure of the joint was normal, there was not abnormal structures such as martensite and bainite. In the comparative example, the fatigue life of the steel rail joint was only 1.50 million times.

### Comparative Example 2

After the steel rail with a specification of 75 kg/m had subjected to the upsetting and removal of the weld collar during the mobile flash welding process, the welded joint was subjected to the post-weld heat treatment. Firstly, the steel rail welded joint formed by welding and having a residual temperature of 1,200° C. was subjected to a first stage cooling at a first cooling rate of 6.0° C./s, so as to lower the railhead surface temperature of the steel rail joint to 720° C.; the steel rail joint was then subjected to a second stage cooling at a second cooling rate of 3° C./s, so as to lower the railhead surface temperature of the steel rail joint to 180° C.; the steel rail joint was finally subjected to a third stage cooling at a third cooling rate of 0.2° C./s, so as to lower the railhead surface temperature of the steel rail joint to the room temperature of 30° C.; such that the steel rail welded joint after the post-weld heat treatment was obtained. During the post-weld heat treatment process, the first stage cooling was natural cooling in the air; a steel rail railhead profiling cooling device was used in the second stage cooling and the third stage cooling, wherein the compressed air was used as a cooling medium to cool the railhead tread and the railhead side face of a steel rail joint; the distance between the cooling device and the steel rail railhead tread was 30 mm; the gas pressure of the compressed air ejected from the cooling device during the second stage cooling process was 0.4 MPa; the gas pressure of the compressed air ejected from the cooling device during the third stage cooling process was 0.1 MPa. An infrared thermometer was used for monitoring the temperature of the steel rail railhead tread.

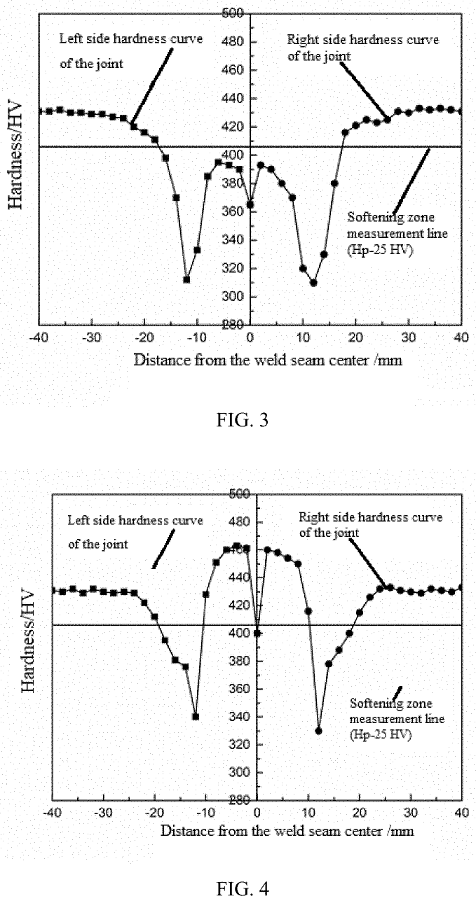

The steel rail joint obtained after welding and under the condition of air cooling from the comparative example was machined into a longitudinal hardness test sample. A Brinell and Vickers hardness tester (model HBV-30A, manufactured by the Laizhou Testing Machine General Factory in Shandong Province) was used for performing the longitudinal Vickers hardness detection on the hardness test sample at a position 4 mm below the steel rail railhead tread by taking 2 mm as the measuring point interval, the measuring points were symmetrically arranged towards the left side and the right side by taking the weld seam as a center. The Vickers hardness test method was performed with reference to the national standard GB/T4340.1-2009 “Metal Vickers Hardness Testing Part 1: experimental methods” and using the HV scale. The hardness test data were illustrated in Table 4, and the distribution effect of the longitudinal hardness of the joints was shown in FIG. 4.

TABLE 4
Distance from the weld seam center/mm

| | | | | | | | | | | | | |
|---|---|---|---|---|---|---|---|---|---|---|---|---|
| Left | Distance | 0 | 2 | 4 | 6 | 8 | 10 | 12 | 14 | 16 | 18 | 20 |
| side | from the | | | | | | | | | | | |
| | weld seam | | | | | | | | | | | |
| | Hardness/HV | 400 | 461 | 463 | 460 | 451 | 428 | 340 | 376 | 381 | 395 | 412 |
| | Distance | 22 | 24 | 26 | 28 | 30 | 32 | 34 | 36 | 38 | 40 | / |
| | from the | | | | | | | | | | | |
| | weld seam | | | | | | | | | | | |
| | Hardness/HV | 422 | 429 | 430 | 429 | 430 | 432 | 429 | 432 | 430 | 431 | / |
| Right | Distance | 0 | 2 | 4 | 6 | 8 | 10 | 12 | 14 | 16 | 18 | 20 |
| side | from the | | | | | | | | | | | |
| | weld seam | | | | | | | | | | | |
| | Hardness/HV | 400 | 460 | 458 | 454 | 450 | 416 | 330 | 378 | 388 | 400 | 415 |
| | Distance | 22 | 24 | 26 | 28 | 30 | 32 | 34 | 36 | 38 | 40 | / |
| | from the | | | | | | | | | | | |
| | weld seam | | | | | | | | | | | |
| | Hardness/HV | 426 | 432 | 433 | 431 | 430 | 429 | 432 | 431 | 430 | 433 | / |

As indicated by the Table 4 and FIG. 4, in regard to the steel rail welded joint without being treated with the post-weld heat treatment method of the present disclosure, the width of the softened area on the left side of the joint weld seam was 9.0 mm, the width of the softened area on the right side of the joint weld seam was 9.0 mm, each of the widths of the softened areas on the both sides of the joint weld seam was not more than 15.0 mm.

With reference to the sampling method shown in FIG. 9, the metallographic structure examination was performed on the metallographic structure sample of the steel rail joint according to the national standard GB/T13298-2015 “Metal Microstructure Examination Method”, the metallographic sample of the steel rail joint was subjected to etching with the nitric acid alcohol solution having a concentration of 3%, and the metallographic structure of the steel rail joint was observed with the German Leica MeF3 optical microscope. The metallographic examination result showed that a large amount of quenched and hardened martensitic structures appeared in the heat affected zones on the left side and the right side of the joint weld seam. The result indicated that under the observation magnification 100× of a metallographic microscope, the percentage content of the martensitic structure of the most serious area in which the martensitic structure appeared reached 8%. Under the comparative example, the fatigue life of the steel rail joint was only 1.80 million times, which was not conducive to the operation safety of railway line.

### Comparative Example 3

After the steel rail with a specification of 75 kg/m had subjected to the upsetting and removal of the weld collar during the mobile flash welding process, the welded joint was subjected to the post-weld heat treatment. Firstly, the steel rail welded joint formed by welding and having a residual temperature of 1,100° C. was subjected to a first stage cooling at a first cooling rate of 7.0° C./s, so as to lower the railhead surface temperature of the steel rail joint to 680° C.; the steel rail joint was then subjected to a second stage cooling at a second cooling rate of 4° C./s, so as to lower the railhead surface temperature of the steel rail joint to 350° C.; the steel rail joint was finally subjected to a third stage cooling at a third cooling rate of 3° C./s, so as to lower the railhead surface temperature of the steel rail joint to the room temperature of 25° C.; such that the steel rail welded joint after the post-weld heat treatment was obtained. During the post-weld heat treatment process, the first stage cooling was natural cooling in the air; a steel rail railhead profiling cooling device was used in the second stage cooling and the third stage cooling, where in the compressed air was used as a cooling medium to cool the railhead tread and the railhead side face of a steel rail joint; the distance between the cooling device and the steel rail railhead tread was 30 mm; the gas pressure of the compressed air ejected from the cooling device during the second stage cooling process was 0.6 MPa; the gas pressure of the compressed air ejected from the cooling device during the third stage cooling process was 0.5 MPa. An infrared thermometer was used for monitoring the temperature of the steel rail railhead tread.

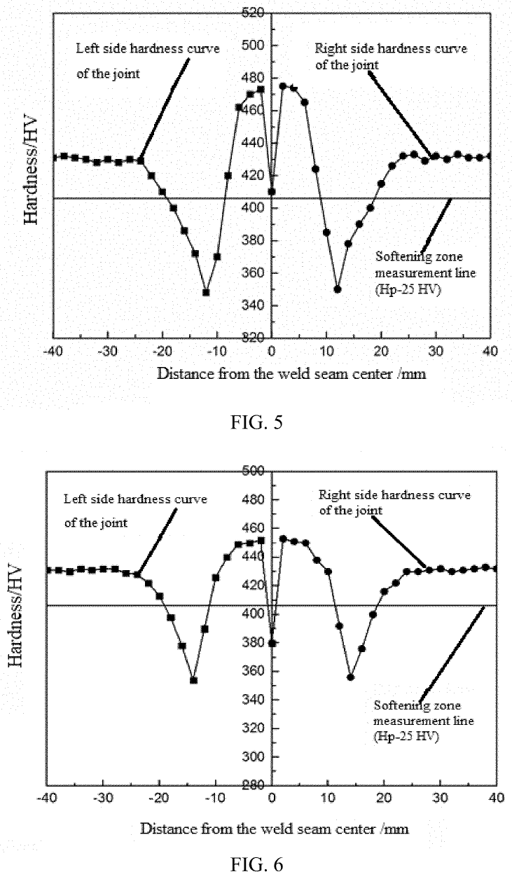

The steel rail joint obtained after welding and under the condition of air cooling from the comparative example was machined into a longitudinal hardness test sample. A Brinell and Vickers hardness tester (model HBV-30A, manufactured by the Laizhou Testing Machine General Factory in Shandong Province) was used for performing the longitudinal Vickers hardness detection on the hardness test sample at a position 4 mm below the steel rail railhead tread by taking 2 mm as the measuring point interval, the measuring points were symmetrically arranged towards the left side and the right side by taking the weld seam as a center. The Vickers hardness test method was performed with reference to the national standard GB/T4340.1-2009 “Metal Vickers Hardness Testing Part 1: experimental methods” and using the HV scale. The hardness test data were illustrated in Table 5, and the distribution effect of the longitudinal hardness of the joints was shown in FIG. 5.

TABLE 5
Distance from the weld seam center/mm

| | | | | | | | | | | | | |
|---|---|---|---|---|---|---|---|---|---|---|---|---|
| Left | Distance | 0 | 2 | 4 | 6 | 8 | 10 | 12 | 14 | 16 | 18 | 20 |
| side | from the | | | | | | | | | | | |
| | weld seam | | | | | | | | | | | |
| | Hardness/HV | 410 | 473 | 470 | 462 | 420 | 370 | 348 | 372 | 386 | 400 | 410 |
| | Distance | 22 | 24 | 26 | 28 | 30 | 32 | 34 | 36 | 38 | 40 | / |
| | from the | | | | | | | | | | | |
| | weld seam | | | | | | | | | | | |
| | Hardness/HV | 420 | 429 | 430 | 428 | 430 | 428 | 430 | 431 | 432 | 431 | / |
| Right | Distance | 0 | 2 | 4 | 6 | 8 | 10 | 12 | 14 | 16 | 18 | 20 |
| side | from the | | | | | | | | | | | |
| | weld seam | | | | | | | | | | | |
| | Hardness/HV | 410 | 475 | 474 | 465 | 424 | 385 | 350 | 378 | 390 | 400 | 415 |
| | Distance | 22 | 24 | 26 | 28 | 30 | 32 | 34 | 36 | 38 | 40 | / |
| | from the | | | | | | | | | | | |
| | weld seam | | | | | | | | | | | |
| | Hardness/HV | 426 | 432 | 433 | 429 | 432 | 430 | 433 | 431 | 431 | 432 | / |

As indicated by the Table 5 and FIG. 5, the average hardness of the base material was 431 HV. In regard to the steel rail welded joint without being treated with the post-weld heat treatment method of the present disclosure, the width of the softened area on the left side of the joint weld seam was 10.0 mm, the width of the softened area on the right side of the joint weld seam was 10.0 mm, each of the widths of the softened areas on the both sides of the joint weld seam was not more than 15.0 mm.

With reference to the sampling method shown in FIG. 9, the metallographic structure examination was performed on the metallographic structure sample of the steel rail joint according to the national standard GB/T13298-2015 “Metal Microstructure Examination Method”, the metallographic sample of the steel rail joint was subjected to etching with the nitric acid alcohol solution having a concentration of 3%, and the metallographic structure of the steel rail joint was observed with the German Leica MeF3 optical microscope. The metallographic examination result showed that a large amount of quenched and hardened martensitic structures appeared in the heat affected zones on the left side and the right side of the joint weld seam. The result indicated that under the observation magnification 100× of a metallographic microscope, the percentage content of the martensitic structure of the most serious area in which the martensitic structure appeared reached 10%. Under the comparative example, the fatigue life of the steel rail joint was only 0.80 million times, which was not conducive to the operation safety of railway line.

### Comparative Example 4

The welded joint was subjected to the post-weld heat treatment according to method of example 1, except that the railhead surface temperature of the steel rail joint was lowered to 200° C. after subjecting to the second stage cooling.

The steel rail joint obtained after welding and under the condition of air cooling from the comparative example was machined into a longitudinal hardness test sample. A Brinell and Vickers hardness tester (model HBV-30A, manufactured by the Laizhou Testing Machine General Factory in Shandong Province) was used for performing the longitudinal Vickers hardness detection on the hardness test sample at a position 4 mm below the steel rail railhead tread by taking 2 mm as the measuring point interval, the measuring points were symmetrically arranged towards the left side and the right side by taking the weld seam as a center. The Vickers hardness test method was performed with reference to the national standard GB/T4340.1-2009 “Metal Vickers Hardness Testing Part 1: experimental methods” and using the HV scale. The hardness test data were illustrated in Table 6, and the distribution effect of the longitudinal hardness of the joints was shown in FIG. 6.

TABLE 6
Distance from the weld seam center/mm

| | | | | | | | | | | | | |
|---|---|---|---|---|---|---|---|---|---|---|---|---|
| Left | Distance | 0 | 2 | 4 | 6 | 8 | 10 | 12 | 14 | 16 | 18 | 20 |
| side | from the | | | | | | | | | | | |
| | weld seam | | | | | | | | | | | |
| | Hardness/HV | 380 | 452 | 450 | 449 | 440 | 426 | 390 | 354 | 378 | 398 | 413 |
| | Distance | 22 | 24 | 26 | 28 | 30 | 32 | 34 | 36 | 38 | 40 | / |
| | from the | | | | | | | | | | | |
| | weld seam | | | | | | | | | | | |
| | Hardness/HV | 422 | 428 | 429 | 432 | 432 | 431 | 432 | 430 | 431 | 431 | / |
| Right | Distance | 0 | 2 | 4 | 6 | 8 | 10 | 12 | 14 | 16 | 18 | 20 |
| side | from the | | | | | | | | | | | |
| | weld seam | | | | | | | | | | | |
| | Hardness/HV | 380 | 453 | 451 | 450 | 438 | 430 | 392 | 356 | 376 | 400 | 416 |
| | Distance | 22 | 24 | 26 | 28 | 30 | 32 | 34 | 36 | 38 | 40 | / |
| | from the | | | | | | | | | | | |
| | weld seam | | | | | | | | | | | |
| | Hardness/HV | 422 | 430 | 430 | 431 | 432 | 430 | 431 | 432 | 433 | 432 | / |

As indicated by the Table 6 and FIG. 6, the average hardness of the base material was 431 HV. In regard to the steel rail welded joint without being treated with the post-weld heat treatment method of the present disclosure, the width of the softened area on the left side of the joint weld seam was 8.0 mm, the width of the softened area on the right side of the joint weld seam was 8.0 mm, each of the widths of the softened areas on the both sides of the joint weld seam was not more than 15.0 mm.

With reference to the sampling method shown in FIG. 9, the metallographic structure examination was performed on the metallographic structure sample of the steel rail joint according to the national standard GB/T13298-2015 “Metal Microstructure Examination Method”, the metallographic sample of the steel rail joint was subjected to etching with the nitric acid alcohol solution having a concentration of 3%, and the metallographic structure of the steel rail joint was observed with the German Leica MeF3 optical microscope. The metallographic examination result showed that a large amount of quenched and hardened martensitic structures appeared in the heat affected zones on the left side and the right side of the joint weld seam. The result indicated that under the observation magnification 100× of a metallographic microscope, the percentage content of the martensitic structure of the most serious area in which the martensitic structure reached 12%. Under the comparative example, the fatigue life of the steel rail joint was only 0.70 million times, which was not conducive to the operation safety of railway line.

### Comparative Example 5

The welded joint was subjected to the post-weld heat treatment according to method of example 1, except that the second stage cooling was carried out at a second cooling rate of 1.5° C./s.

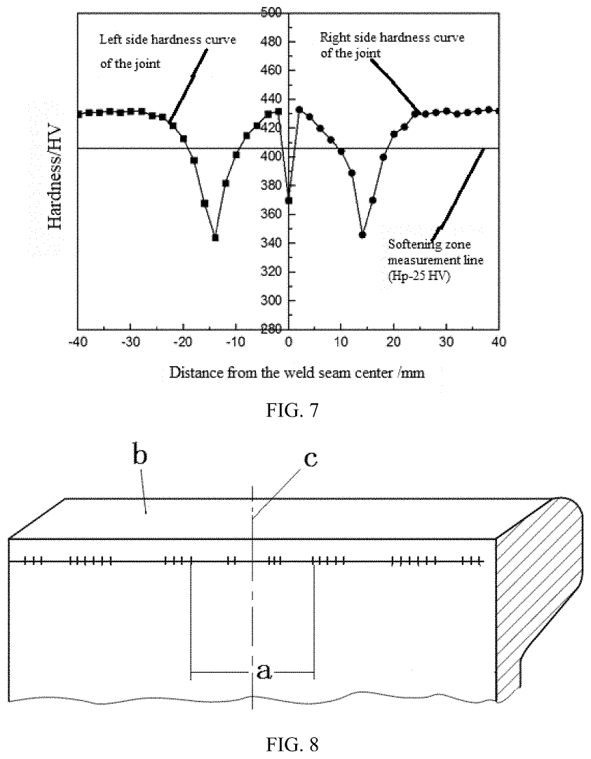

The steel rail joint obtained after welding and under the condition of air cooling from the comparative example was machined into a longitudinal hardness test sample. A Brinell and Vickers hardness tester (model HBV-30A, manufactured by the Laizhou Testing Machine General Factory in Shandong Province) was used for performing the longitudinal Vickers hardness detection on the hardness test sample at a position 4 mm below the steel rail railhead tread by taking 2 mm as the measuring point interval, the measuring points were symmetrically arranged towards the left side and the right side by taking the weld seam as a center. The Vickers hardness test method was performed with reference to the national standard GB/T4340.1-2009 “Metal Vickers Hardness Testing Part 1: experimental methods” and using the HV scale. The hardness test data were illustrated in Table 7, and the distribution effect of the longitudinal hardness of the joints was shown in FIG. 7.

TABLE 7
Distance from the weld seam center/mm

| | | | | | | | | | | | | |
|---|---|---|---|---|---|---|---|---|---|---|---|---|
| Left | Distance | 0 | 2 | 4 | 6 | 8 | 10 | 12 | 14 | 16 | 18 | 20 |
| side | from the | | | | | | | | | | | |
| | weld seam | | | | | | | | | | | |
| | Hardness/HV | 370 | 432 | 430 | 422 | 415 | 402 | 382 | 344 | 368 | 398 | 413 |
| | Distance | 22 | 24 | 26 | 28 | 30 | 32 | 34 | 36 | 38 | 40 | / |
| | from the | | | | | | | | | | | |
| | weld seam | | | | | | | | | | | |
| | Hardness/HV | 422 | 428 | 429 | 432 | 432 | 431 | 432 | 431 | 431 | 430 | |
| Right | Distance | 0 | 2 | 4 | 6 | 8 | 10 | 12 | 14 | 16 | 18 | 20 |
| side | from the | | | | | | | | | | | |
| | weld seam | | | | | | | | | | | |
| | Hardness/HV | 370 | 433 | 428 | 420 | 412 | 404 | 389 | 346 | 370 | 400 | 416 |
| | Distance | 22 | 24 | 26 | 28 | 30 | 32 | 34 | 36 | 38 | 40 | / |
| | from the | | | | | | | | | | | |
| | weld seam | | | | | | | | | | | |
| | Hardness/HV | 421 | 430 | 430 | 431 | 432 | 430 | 431 | 432 | 433 | 432 | / |

As indicated by the Table 7 and FIG. 7, the average hardness of the base material was 431 HV. In regard to the steel rail welded joint without being treated with the post-weld heat treatment method of the present disclosure, the width of the softened area on the left side of the joint weld seam was 10.0 mm, the width of the softened area on the right side of the joint weld seam was 9.0 mm, each of the widths of the softened areas on the both sides of the joint weld seam was not more than 15.0 mm.

With reference to the sampling method shown in FIG. 9, the metallographic structure examination was performed on the metallographic structure sample of the steel rail joint according to the national standard GB/T13298-2015 “Metal Microstructure Examination Method”, the metallographic sample of the steel rail joint was subjected to etching with the nitric acid alcohol solution having a concentration of 3%, and the metallographic structure of the steel rail joint was observed with the German Leica MeF3 optical microscope. The metallographic examination result showed that a large amount of quenched and hardened martensitic structures appeared in the heat affected zones on the left side and the right side of the joint weld seam. The result indicated that under the observation magnification 100× of a metallographic microscope, the percentage content of the martensitic structure of the most serious area in which the martensitic structure appeared reached 6%. Under the comparative example, the fatigue life of the steel rail joint was only 1.40 million times, which was not conducive to the operation safety of railway line.

As can be seen by comparing the weld joint railhead tread longitudinal hardness and softened region widths of the joints in FIGS. 1-7, and Tables 1-7, by adopting the post-weld heat treatment method provided by the present disclosure to carry out post-weld heat treatment on the hypoeutectoid steel rail joint, the longitudinal average hardness of the steel rail joint in the area which is ±20 mm away from the center of the weld seam can satisfy the range of ±30 HV of the average hardness of the corresponding steel rail base metal (excluding the decarburized weld seam center line, the hardness is low, as the high temperature steel rail welding brings about decarburization of the weld seam center and burning loss of elements), the width of the softening area at both sides of the weld seam of the joint is not more than 15 mm. In addition, the percentage content of martensitic structure possibly appearing in the metallographic structure of the welded joint of the steel rail may be controlled within the range of <1%. Moreover, the fatigue life of the steel rail joint can reach 3 million times, which is beneficial to ensuring the operation safety of the railway system.

The above content describes in detail the preferred embodiments of the present disclosure, but the present disclosure is not limited thereto. A variety of simple modifications can be made in regard to the technical solutions of the present disclosure within the scope of the technical concept of the present disclosure, including a combination of individual technical features in any other suitable manner, such simple modifications and combinations thereof shall also be regarded as the content disclosed by the present disclosure, each of them falls into the protection scope of the present disclosure.

What is claimed is:

1. A post-weld heat treatment method for 1,300 MPa-level low-alloy heat treated steel rail, wherein the method comprises the following steps:
(1) subjecting a steel rail welded joint formed by welding and having a residual temperature of 900-1,100° C. to a first stage cooling so as to lower the welded joint surface temperature to 650-720° C., wherein the first stage cooling mode is natural cooling in the air, and the cooling rate is within a range of 4-6° C./s;
(2) subjecting the steel rail welded joint to a second stage cooling so as to lower the welded joint surface temperature to 480-550° C., wherein the second stage cooling adopts a steel rail railhead profiling cooling device for cooling, the cooling medium is compressed air or water mist mixed gas, and the cooling rate is within a range of 2-3.5° C./s;
(3) further subjecting the steel rail welded joint to a third stage cooling so as to lower the welded joint surface temperature to 10-30° C., wherein the third stage cooling adopts a steel rail railhead profiling cooling device for cooling, the cooling medium is compressed air or water mist mixed gas, and the cooling rate is within a range of 0.2-0.8° C./s; wherein a tensile strength of a steel rail base metal of the steel rail welded joint is 1,300 MPa, and the steel rail base metal comprises the following chemical components: 0.75-0.84 wt % of C, 0.6-0.85 wt % of Si, 0.8-1 wt % of Mn, 0.5-0.8 wt % of Cr, ≤0.02 wt % of P, ≤0.02 wt % of S, ≤0.01 wt % of V, the balance of Fe and inevitable impurities.

2. The method of claim 1, wherein the steel rail welded joint in step (1) is formed by welding with a steel rail mobile flash welding machine.

3. The method of claim 2, wherein a steel rail welded joint formed by welding and having a residual temperature of 1,000-1,080° C. is subjected to a first stage cooling in step (1).

4. The method of claim 3, wherein a cooling rate of the first-stage cooling in step (1) is within a range of 5.5-6° C./s.

5. The method of claim 1, wherein the second stage cooling in step (2) is performed with a distance of 18-30 mm between the steel rail railhead profiling cooling device and the steel rail railhead tread.

6. The method of claim 5, wherein a pressure of the compressed air or water mist mixed gas ejected from the steel rail railhead profiling cooling device during the second stage cooling in step (2) is within a range of 0.2-0.4 MPa.

7. The method of claim 5, wherein a cooling rate of the second stage cooling in step (2) is within a range of 2.5-3° C./s.

8. The method of claim 1, wherein the third stage cooling in step (3) is performed with a distance of 18-30 mm between the steel rail railhead profiling cooling device and the steel rail railhead tread.

9. The method of claim 8, wherein a pressure of the compressed air or water mist mixed gas ejected from the steel rail railhead profiling cooling device during the third stage cooling in step (3) is within a range of 0.04-0.15 MPa.

10. The method of claim 9, where in the pressure of the compressed air or water mist mixed gas ejected from the steel rail railhead profiling cooling device during the third stage cooling in step (3) is within a range of 0.08-0.12 MPa.

11. The method of claim 1, wherein a cooling rate of the third stage cooling in step (3) is within a range of 0.55-0.6° C./s.
